(19) United States
(12) Patent Application Publication
(10) Pub. No.: US 2013/0142982 A1
(43) Pub. Date: Jun. 6, 2013

(54) DOUBLE-SIDED PRESSURE-SENSITIVE ADHESIVE SHEET

(71) Applicant: Nitto Denko Corporation, Osaka (JP)

(72) Inventors: Hakaru HORIGUCHI, Osaka (JP); Noritsugu DAIGAKU, Osaka (JP); Takahiro NONAKA, Osaka (JP); Yoshihisa FURUTA, Osaka (JP)

(73) Assignee: NITTO DENKO CORPORATION, Osaka (JP)

(21) Appl. No.: 13/705,840

(22) Filed: Dec. 5, 2012

(30) Foreign Application Priority Data
Dec. 6, 2011 (JP) 2011-266993

(51) Int. Cl. C09J 7/04

(52) U.S. Cl. CPC C09J 7/045
USPC 428/41.8

(57) ABSTRACT

There is provided a double-sided pressure-sensitive adhesive sheet including a pressure-sensitive adhesive body having pressure-sensitive adhesive faces (a) and (b) on both sides thereof, and a release liner (A) provided at least on the pressure-sensitive adhesive face (a) of the pressure-sensitive adhesive body. The release liner (A) includes a paper-based base material and a release layer on a face of the paper-based base material, the release layer being in contact with the pressure-sensitive adhesive face (a). The ratio of an interlayer strength of the release liner (A) with respect to a peeling force of the release liner (A) in a peeling test at 90° with respect to the pressure-sensitive adhesive face (a) is 15 or more. The double-sided pressure-sensitive adhesive sheet may preferably be used as a double-sided pressure-sensitive adhesive sheet for a flexible printed circuit board.

### FIELD OF THE INVENTION

The present invention relates to a double-sided pressure-sensitive adhesive sheet.

### BACKGROUND OF THE INVENTION

Wiring circuit boards are used in electronic devices and, as these wiring circuit boards, flexible printed circuit boards (sometimes referred to as “FPC”) are widely used. FPC's are normally used in a state of being fixed to a housing or a reinforcement plate (aluminum plate, stainless steel plate, polyimide plate, or the like) of an electronic device. An adhesive sheet (pressure-sensitive adhesive sheet) is used during the fixing (joining together) to the above-described housing or reinforcement plate (refer to JP-A-2006-302941).

The pressure-sensitive adhesive sheets used during the fixing of the FPC are sometimes used after pull tab processing from the viewpoint that having a pull tab (pull tab for peeling) used as a gripping part at the time of peeling a release liner from the pressure-sensitive adhesive sheet facilitates the peeling of the release liner and improves the peeling operability. Examples of the pull tab processed pressure-sensitive adhesive sheet (pressure-sensitive adhesive sheet having a pull tab attached thereto) include ones having the configuration shown in FIG. 5. Specifically, this is a configuration in which, in a double-sided pressure-sensitive adhesive sheet 41 provided with a release liner 11 and a release liner 31 on both surfaces of a pressure-sensitive adhesive body 21, a pull tab 13 is provided in a part of the release liner 11.

As a pull tab processing method, for example, there is known a (half cutting) method in which, during punching out processing of a pressure-sensitive adhesive sheet having release liners on the pressure-sensitive adhesive faces of the pressure-sensitive adhesive sheet, a portion other than a release liner forming a pull tab is cut out and only the release liner forming the pull tab is left uncut. However, as shown in FIG. 3, during the punching out of the pressure-sensitive adhesive body 21 and the forming of the pull tab on the release liner 11, there are cases where a slit 5 is also added to the release liner 11 and a pull tab 6 in which a slit is added is formed. When the pull tab 6 in which a slit is added is gripped and the release liner 11 is peeled off from the pressure-sensitive adhesive body 21, the release liner 11 is interlaminarly ripped and torn from the slit 5, and, as shown in FIG. 4, there have been problems in that there are cases where the release liner 7 interlaminarly ripped is left on the pressure-sensitive adhesive face of the pressure-sensitive adhesive body 21, and the peeling operability is deteriorated. In particular, the above-described problems were likely to occur in paper-based base materials.

### SUMMARY OF THE INVENTION

Accordingly, for example, an object of the invention is to provide a double-sided pressure-sensitive adhesive sheet having excellent peeling operability and for which problems such as the release liner being interlaminarly ripped and torn from the slit do not occur when the release liner is peeled off from the pressure-sensitive adhesive body even in a case where a slit has been added to the release liner by half cut processing such as pull tab processing.

As the result of intensive research in order to achieve the above-described object, the present inventors found that, in a double-sided pressure-sensitive adhesive sheet having a release liner in which the base material is a paper-based base material, on a pressure-sensitive adhesive face of a pressure-sensitive adhesive body, by controlling the ratio of the interlayer strength of the above-described release liner with respect to the peeling force of the release liner in a peeling test at 90° with respect to the above-described pressure-sensitive adhesive face to be within a specific range, it is possible to obtain a double-sided pressure-sensitive adhesive sheet with excellent peeling operability even in a case where a slit has been added to the release liner by half cut processing such as pull tab processing, thereby completing the present invention.

Namely, the present invention provides a double-sided pressure-sensitive adhesive sheet, including a pressure-sensitive adhesive body having pressure-sensitive adhesive faces (a) and (b) on both sides thereof, and a release liner (A) provided at least on the pressure-sensitive adhesive face (a) of the pressure-sensitive adhesive body,

wherein the release liner (A) includes a paper-based base material and a release layer on a face of the paper-based base material, the release layer being in contact with the pressure-sensitive adhesive face (a), and

wherein a ratio (an interlayer strength of the release liner (A)/a peeling force of the release liner (A) in a peeling test at 90° with respect to the pressure-sensitive adhesive face (a)) of the interlayer strength of the release liner (A) with respect to the peeling force of the release liner (A) in the peeling test at 90° with respect to the pressure-sensitive adhesive face (a) is 15 or more.

In the above-mentioned double-sided pressure-sensitive adhesive sheet, the peeling force of the release liner (A) in the peeling test at 90° with respect to the pressure-sensitive adhesive face (a) is preferably 0.15 N/50 mm or more.

In the above-mentioned double-sided pressure-sensitive adhesive sheet, the interlayer strength of the release liner (A) is preferably 5 N/50 mm or more.

In the above-mentioned double-sided pressure-sensitive adhesive sheet, the pressure-sensitive adhesive body preferably includes an acrylic pressure-sensitive adhesive layer.

In the above-mentioned double-sided pressure-sensitive adhesive sheet, the release layer is preferably a release layer formed by a silicone-based releasing agent.

In the above-mentioned double-sided pressure-sensitive adhesive sheet, the paper-based base material is preferably a paper-based base material selected from a group consisting of glassine paper, wood free paper, and craft paper.

In the above-mentioned double-sided pressure-sensitive adhesive sheet, the release liner (A) preferably has a thickness of 50 to 200 μm.

It is preferable that the above-mentioned double-sided pressure-sensitive adhesive sheet further includes a pull tab attached thereto.

The above-mentioned double-sided pressure-sensitive adhesive sheet is preferably a double-sided pressure-sensitive adhesive sheet for a flexible printed circuit board.

By virtue of having the above-described configuration, the double-sided pressure-sensitive adhesive sheet of the present invention has excellent peeling operability and does not lead to problems such as the release liner being interlaminarly ripped and torn from a slit when the release liner is peeled from the pressure-sensitive adhesive body even in a case where the slit has been added to the release liner by half cut processing such as pull tab processing, for example.

### BRIEF DESCRIPTION OF THE DRAWINGS

FIG. 1 is a schematic view (plan view) representing an embodiment of a double-sided pressure-sensitive adhesive sheet with a pull tab attached.

FIG. 2 is a schematic view (cross-sectional view along X-X in FIG. 1) representing an embodiment of a double-sided pressure-sensitive adhesive sheet with a pull tab attached.

FIG. 3 is a schematic view (cross-sectional view) representing an embodiment of a double-sided pressure-sensitive adhesive sheet with a pull tab to which a slit is added attached.

FIG. 4 is a schematic view (cross-sectional view) showing an embodiment of a state where a release liner interlaminarly ripped is left on a pressure-sensitive adhesive face of the pressure-sensitive adhesive sheet when the release liner is peeled from the pressure-sensitive adhesive sheet.

FIG. 5 is a schematic view (cross-sectional view) representing an embodiment of a double-sided pressure-sensitive adhesive sheet with a pull tab attached.

### DESCRIPTION OF REFERENCE NUMERALS AND SIGNS

1: RELEASE LINER (A)
11: RELEASE LINER
12: PULL TAB (PULL TAB FOR PEELING)
13: PULL TAB (PULL TAB FOR PEELING)
2: PRESSURE-SENSITVE ADHESIVE BODY
21: PRESSURE-SENSITVE ADHESIVE BODY
3: RELEASE LINER (B)
31: RELEASE LINER
4: DOUBLE SIDED PRESSURE-SENSITVE ADHESIVE SHEET WITH PULL TAB ATTACHED
41 DOUBLE SIDED PRESSURE-SENSITVE ADHESIVE SHEET WITH PULL TAB ATTACHED
5: SLIT
6: SLITTED PULL TAB
7: INTERLAMINARLY RIPPED RELEASE LINER

### DETAILED DESCRIPTION OF THE INVENTION

The double-sided pressure-sensitive adhesive sheet of the present invention includes a release liner (A) on at least a pressure-sensitive adhesive face (a) of a pressure-sensitive adhesive body in which the surfaces of both sides are pressure-sensitive adhesive faces and the above-described release liner (A) includes a release layer on at least the above-described pressure-sensitive adhesive face (a) side of a paper-based base material.

The double-sided pressure-sensitive adhesive sheet of the present invention may have a release liner (B) on the pressure-sensitive adhesive face (may be referred to as pressure-sensitive adhesive face (b)) of a surface of the opposite side to the pressure-sensitive adhesive face (a) of the pressure-sensitive adhesive body. In other words, the double-sided pressure-sensitive adhesive sheet of the present invention needs to have a release liner (A) provided on the pressure-sensitive adhesive face (a) and may or may not be provided with a release liner (B) on the pressure-sensitive adhesive face (b).

In a case where the double-sided pressure-sensitive adhesive sheet of the present invention has a release liner (B), a double-sided pressure-sensitive adhesive sheet (that is, a double separator type double-sided pressure-sensitive adhesive sheet) in which release liners are provided on the surfaces of both sides of the above-described pressure-sensitive adhesive body is formed. Meanwhile, in a case where the release liner (B) is not provided, a double-sided pressure-sensitive adhesive sheet (that is, a single separator type double-sided pressure-sensitive adhesive sheet) in which the release liner (A) is provided on the pressure-sensitive adhesive face (a) of the above-described pressure-sensitive adhesive body and a release liner is not provided on the pressure-sensitive adhesive face (b) is formed. The double-sided pressure-sensitive adhesive sheet of the present invention is not particularly limited; however, it is preferably a double separator type double-sided pressure-sensitive adhesive sheet.

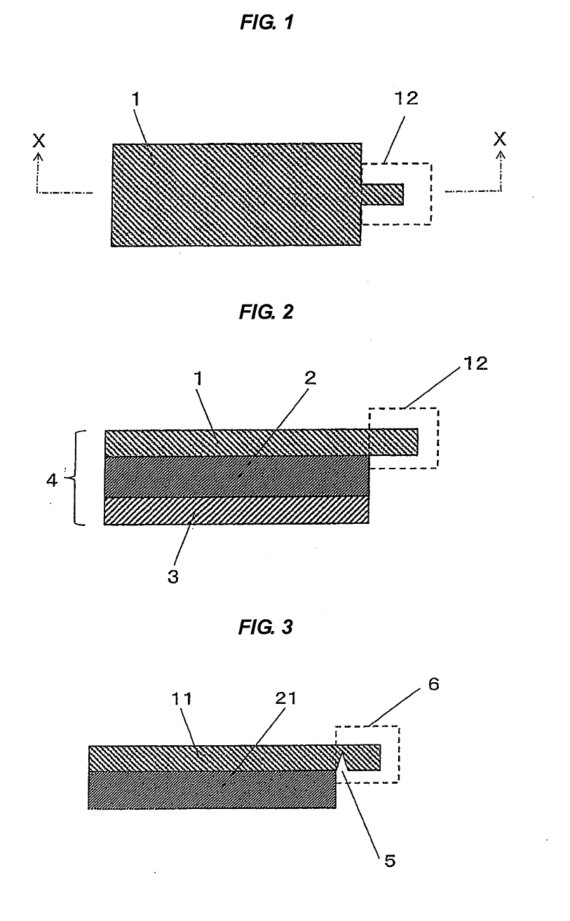

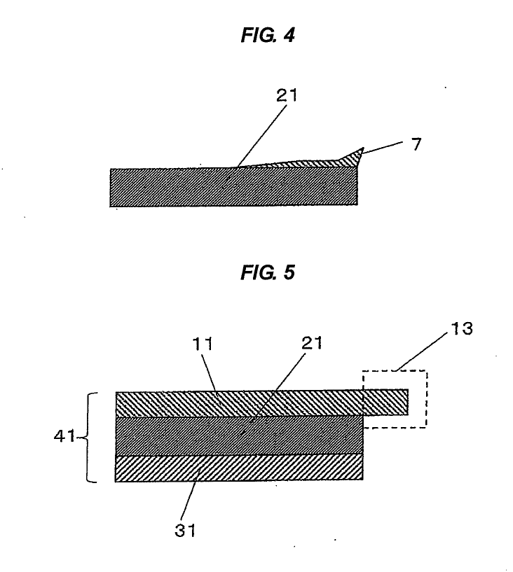

Incidentally, the double separator type double-sided pressure-sensitive adhesive sheet respectively having the release liner (A) provided on the pressure-sensitive adhesive face (a) of the pressure-sensitive adhesive body and the release liner (B) provided on the pressure-sensitive adhesive face (b) of the pressure-sensitive adhesive body is set such that the release liner (A) is a release liner in which a pull tab is formed during pull tab processing and the release liner (B) is a release liner cut out together with the pressure-sensitive adhesive body during the pull tab processing (FIG. 1 and FIG. 2).

In the present specification, the term “pressure-sensitive adhesive sheet” in principle indicates ones including release liners (separators) and the “remaining portion after peeling the release liner from the pressure-sensitive adhesive sheet” may sometimes refer to the “pressure-sensitive adhesive body”. In the present specification, the term “pressure-sensitive adhesive sheet” also includes ones in tape form, that is, a “pressure-sensitive adhesive tape”.

### Release Liner (A)

The above-described release liner (A) includes at least a paper-based base material and a release layer. The above-described release liner (A) is not particularly limited; however, for example, the release liner may have a release layer only on one surface of the paper-based base material or may have release layers on the surfaces of both sides of the paper-based base material.

In the present specification, the release layer in contact with the above-described pressure-sensitive adhesive face (a) of the release liner (A) is sometimes referred to as the release layer (I). In addition, in a case where the release liner (A) has a release layer on the surfaces of both sides of the paper-based base material, the release layer provided on the surface of the opposite side to the release layer (I) is sometimes referred to as the release layer (II).

### (Paper-Based Base Material)

The above-described paper-based base material is not particularly limited and various types of paper-based base material can be appropriately selected and used. Examples thereof includes Japanese paper, Western paper, wood free paper, glassine paper, craft paper, clupak paper, crepe paper, clay-coated paper, synthetic paper, resin laminated paper (paper in which resin is laminate-processed on the surface of a base sheet), resin coated paper (paper in which resin is coated on the surface of the base sheet), and the like. Among these, from the viewpoint of heat resistance, glassine paper, wood free paper, and craft paper are preferable, and glassine paper is particularly preferable. That is, the above-described paper-based base material is preferably selected from a group consisting of glassine paper, wood free paper, and craft paper.

The above-described paper-based base material may take a form of either a single layer or a multilayered body.

In the above-described paper-based base materials, it is possible to appropriately use an arbitrary component within a range which does not adversely affect the effect of the present invention. Examples of the above-described arbitrary component include loading material, sizing agents, and the like. Meanwhile, since there are cases where the heat resistance property of the paper-based base material is deteriorated, the paper-based base material preferably does not include a paper strengthening agent.

As necessary, the surface of the above-described paper-based base material can be subjected to various types of surface treatments such as corona discharge treatment or various types of surface processing such as embossing processing.

The basis weight of the above-described paper-based base material is not particularly limited; however, 55 to 120 g/m² is preferable, and 60 to 110 g/m² is more preferable. By setting the basis weight to 55 g/m² or more, the tearing strength or the tensile strength of the release liner (A) is improved. On the other hand, by setting the basis weight to 120 g/m² or less, it is possible to suppress costs.

The thickness of the above-described paper-based base material is not particularly limited; however, 50 to 200 μm is preferable, and 60 to 120 μm is more preferable. By setting the thickness to 50 μm or more, the tearing strength or the tensile strength of the release liner (A) is improved, and thus the release liner (A) is not easily cut during half cut processing such as pull tab processing and also the pull tab is not easily cut and separated when the pull tab is gripped and the release liner (A) is peeled from the pressure-sensitive adhesive sheet. On the other hand, by setting the thickness to 200 μm or less, it is possible to suppress costs.

The above-described paper-based base material preferably has heat resistance from the viewpoint of avoiding thermal deterioration even in a case of fixing the FPC to the housing or the like of the electronic device using the double-sided pressure-sensitive adhesive sheet of the present invention and then performing treatment with a high temperature step such as a solder reflow step. Examples of paper-based base material having heat resistance include paper-based base material subjected to a neutral paper forming treatment. As this kind of paper-based base material subjected to a neutral paper forming treatment, neutral paper (acid-free paper) may be suitably used. Since the above-described neutral paper is neutralized, changes in the strength, the external appearance, or the like are suppressed or prevented even after exposure to high temperature, and the paper has excellent heat resistance.

The neutral paper can be manufactured by a method of adjusting the raw material to neutral in a paper making step, a method using a neutral sizing agent as the sizing agent, or the like.

As the above-described paper-based base material, for example, it is possible to use commercial products such as trade name “RRP-70(T)” (glassine paper, manufactured by Tomoegawa Paper Co., Ltd.), “NSGP-RT100” (glassine paper, manufactured by Oji Specialty Paper Co., Ltd.), or the like.

### (Release Layer (I))

The releasing agent forming the above-described release layer (I) is not particularly limited; however, the agent preferably includes at least a main agent and a catalyst.

The above-described main agent is not particularly limited; however, examples thereof include silicone-based compounds, long chain alkyl-based compounds, fluorine-based compounds, molybdenum sulfide, and the like. Among these, silicone-based compounds are preferable from the viewpoint of ease of controlling the peelability. That is, the above-described release layer (I) is preferably a release layer (silicone-based release layer) formed by a releasing agent (silicone-based releasing agent) containing a silicone-based compound. The above-described main agent may be used alone or may be used in combination of two or more types.

The above-described silicone-based compound is not particularly limited; however, examples thereof include ionizing radiation curable silicone-based compounds such as ultraviolet ray curable silicone-based compounds; thermocurable silicone-based compounds; and the like. Among these, in terms of being able to further reduce the peeling force of the release liner (A) with respect to the pressure-sensitive adhesive face (a) and facilitating improvement of the peeling operability, thermocurable silicone-based compounds are preferable.

The above-described thermocurable silicone-based compounds are not particularly limited as long as they are silicone-based compounds in which a cross-linking reaction (curing reaction) proceeds as a result of heating; however, from the viewpoint of peeling force stability, heat addition reaction type silicone-based compounds which foams a release layer by curing according to addition reaction type cross-linking caused by heat are preferable.

For example, the above-described heat addition reaction type silicone-based compound is preferably a polyorganosiloxane (sometimes referred to as an “alkenyl group-containing silicone”) containing an alkenyl group in the molecule, or a polyorganosiloxane (sometimes referred to as a “hydrosilyl group-containing silicone”) containing a hydrosilyl group as a functional group in the molecule.

As the above-described alkenyl group-containing silicone, a polyorganosiloxane having a structure in which an alkenyl group is bonded to a silicon atom (for example, a terminal silicon atom, a silicon atom inside the main chain, or the like) forming the main chain or the skeleton is preferable, and a polyorganosiloxane having two or more alkenyl groups bonded to a silicon atom forming the main chain or the skeleton in the molecule (in one molecule) is particularly preferable.

The above-described alkenyl groups are not particularly limited; however, examples thereof include vinyl groups (ethenyl groups), allyl groups (2-propenyl groups), butenyl groups, pentenyl groups, hexenyl groups, and the like. Among these, vinyl groups, and hexenyl groups are preferable.

In addition, the above-described polyorganosiloxane forming the main chain or the skeleton in the alkenyl group-containing silicone is not particularly limited; however, examples thereof include polyalkylalkylsiloxanes (polydialkylsiloxane) such as polydimethylsiloxane, polydiethylsiloxane, and polymethylethylsiloxane; cyclic siloxanes such as hexamethylcyclotrisiloxane, octamethylcyclotetrasiloxane, and decamethylcyclopentasiloxane; polyalkylarylsiloxanes; copolymers of a plurality of types of silicon atom containing monomers (for example, poly(dimethylsiloxane-diethylsiloxane) and the like), and the like. Among these, polydimethylsiloxane and octamethylcyclotetrasiloxane are preferable. As the above-described polydimethylsiloxanes, specifically, polydimethylsiloxane having a vinyl group as a functional group, polydimethylsiloxane having a hexenyl group as a functional group, or mixtures thereof are preferable.

As the above-described hydrosilyl group-containing silicone, polyorganosiloxanes having a hydrogen atom bonded to a silicon atom (for example, a terminal silicon atom, a silicon atom inside the main chain, or the like) forming the main chain or the skeleton are preferable, and polyorganosiloxane having two or more hydrogen atoms bonded to a silicon atom forming the main chain or the skeleton in the molecule (in one molecule) is particularly preferable. In addition, as the above-described hydrosilyl group-containing silicone, specifically, polymethylhydrogensiloxane, poly(dimethylsiloxane-methylhydrogensiloxane) or the like is preferable.

As the above-described main agent, for example, it is possible to use commercial products such as trade name “X-62-1492” (manufactured by Shin-Etsu Chemical Co., Ltd.), trade name “AST-8” (manufactured by Arakawa Chemical Industries Ltd.), trade name “BY24-4538” (manufactured by Toray Dow Corning Co., Ltd.) (the above are thermocurable type silicone-based releasing agents).

The above-described catalyst is not particularly limited; however, examples thereof include platinum-based catalysts, tin-based catalysts, and the like. Among these, platinum-based catalysts are preferable, and at least one platinum-based catalyst selected from a group consisting of chloroplatinic acid, an olefin complex of platinum, and an olefin complex of chloroplatinic acid is more preferable. The above-described catalysts may be used alone or may be used in combination of two or more types.

As the above-described catalysts, for example, it is possible to use commercial products such as trade name “CAT-PL-56” (manufactured by Shin-Etsu Chemical Co., Ltd., platinum-based catalyst), trade name “CATA12070” (manufactured by Bluestar Silicons, platinum-based catalyst), and the like.

The above-described releasing agents (in particular, thermocurable type silicone-based releasing agents) preferably contain an organic solvent. In other words, the above-described releasing agents are preferably solvent type releasing agents. The above-described organic solvents are not particularly limited; however, from the viewpoint of uniformly dissolving the constituent components of the releasing agent, examples thereof include hydrocarbon-based solvents (alicyclic hydrocarbons, aliphatic hydrocarbons, or the like) such as cyclohexane, hexane, and heptane; aromatic solvents (aromatic hydrocarbons, and the like) such as toluene and xylene; ester-based solvents (esters) such as ethyl acetate and methyl acetate; ketone-based solvents (ketones) such as acetone and methyl ethyl ketone; alcohol-based solvents (alcohols) such as methanol, ethanol, and butanol; and the like. The above-described organic solvents can be used alone or two or more types can be mixed and used.

The above-described releasing agents (in particular, thermocurable type silicone-based releasing agents) may include a reaction inhibitor in order to impart a storage stability property at room temperature. For example, it is possible to use reaction inhibitors such as 3,5-dimethyl-hexyne-3-ol, 3-methyl-1-pentene-3-ol, 3-methyl-3-pentene-1-in, 3,5-dimethyl-3-hexene-1-in, or the like.

In addition, the above-described releasing agents (in particular, thermocurable type silicone-based releasing agents) may contain a releasing control agent or the like. For example, releasing control agents such as MQ resin and the like, polyorganosiloxanes (polydimethylsiloxane with terminals blocked with a trimethylsiloxy group) not containing any one of an alkenyl group and a hydrosilyl group, and the like may be included. The content of the above-described releasing control agent is not particularly limited; however, 10 to 50 parts by weight with respect to the main agent (for example, in the case of a heat addition reaction type silicone-based releasing agent, alkenyl group-containing silicone and/or hydrosilyl containing silicone) (100 parts by weight) is preferable.

Furthermore, as necessary, the above-described releasing agent may contain various types of additive component (additives). The above-described additive components are not particularly limited; however, examples thereof include fillers, antistatic agents, antioxidants, ultraviolet light absorbers, plasticizers, colorants (dyes, pigments, and the like), or the like.

### (Release Layer (II))

The releasing agent forming the above-described release layer (II) may use a known or conventional releasing agent without being particularly limited. For example, the releasing agent forming the release layer (II) may be the same as the releasing agent forming the release layer (I), or may be different.

In a case where the double-sided pressure-sensitive adhesive sheet of the present invention is a single separator type double-sided pressure-sensitive adhesive sheet and the release liner (A) has a release layer (I) and a release layer (II) on the surfaces of both sides of the paper-based base material, by winding the double-sided pressure-sensitive adhesive sheet into a rolled form, a form may be adopted in which the release layer (I) is in contact with the above-described pressure-sensitive adhesive face (a) and the release layer (II) is in contact with the above-described pressure-sensitive adhesive face (b) (the release layer (II) may be the back releasing layer). In addition, when the roll is rewound, the release layer (II) is preferably used as a release layer which is peeled off prior to the release layer (I).

Examples of preferable specific configurations of the above-described release liner (A) include a release liner in which a release layer (I) formed by a thermocurable type silicone-based releasing agent is formed on one surface of a paper-based base material, among which, a release liner in which a release layer (I) formed by a thermocurable type silicone-based releasing agent is formed on one surface of a glassine paper is preferable.

The peeling force (sometimes referred to as the “peeling force of the release liner (A)”) of the above-described release liner (A) in the peeling test at 90° with respect to the above-described pressure-sensitive adhesive face (a) is not particularly limited; however, 0.15 N/50 mm or more (0.15 to 2.0 N/50 mm) is preferable, and 0.20 to 1.0 N/50 mm is more preferable. By setting the peeling force of the release liner (A) to 0.15 N/50 mm or more, it is possible to suitably protect the pressure-sensitive adhesive face (a) of the pressure-sensitive adhesive body. In a case where the peeling force of the release liner (A) is 2.0 N/50 mm or less, the release liner (A) becomes less easily interlaminarly ripped and torn and the peeling operability is improved when the release liner (A) is peeled off, even in cases such as where a slit has been added to the release liner (A).

The peeling force in the peeling test at 90° with respect to the above-mentioned pressure-sensitive adhesive face can be measured according to the standard of JIS Z0237. In detail, it is possible to perform measurement according to the method described in “(1) Peeling force of Release liner” of (Evaluation) to be described below.

The interlayer strength (interlaminar strength) of the above-described release liner (A) is not particularly limited; however, 5 N/50 mm or more is preferable, and 8 N/50 mm or more is more preferable. By setting the interlayer strength of the above-described release liner (A) to 5 N/50 mm or more, the release liner (A) becomes less easily interlaminarly ripped and torn and the peeling operability is improved when the release liner (A) is peeled off, even in cases such as where a slit has been added to the release liner (A).

Here, in a case where the release liner (A) is formed only of the paper-based base material and the release layer, the interlayer strength of the release liner (A) is almost equal to the interlayer strength of the paper-based base material.

The interlayer strength described above can be measured according to a method described in “(2) Interlayer Strength of Release liner” of (Evaluation) to be described below.

For the release liner (A), the ratio (interlayer strength of the release liner (A)/peeling force of the release liner (A) in the peeling test at 90° with respect to the above-described pressure-sensitive adhesive face (a)) of the interlayer strength of the release liner (A) with respect to the peeling force of the release liner (A) in the peeling test at 90° with respect to the above-described pressure-sensitive adhesive face (a) is 15 or more, preferably 16 or more, more preferably 18 or more, even more preferably 20 or more, and particularly preferably 25 or more. By setting the ratio of the interlayer strength of the release liner (A) with respect to the peeling force of the release liner (A) in the peeling test at 90° with respect to the pressure-sensitive adhesive face (a) to 15 or more, even in cases such as where a slit has been added to the release liner (A), the release liner (A) becomes less easily interlaminarly ripped and torn when the release liner (A) is peeled from the pressure-sensitive adhesive body and the peeling operability is excellent since defects such as parts of the release liner (A) initerlaminarly ripped being left in the pressure-sensitive adhesive body are less likely to occur.

The thickness of the above-described release liner (A) is not particularly limited; however, for example, 50 to 200 μm is preferable and 60 to 120 μm is more preferable. When the thickness is 50 μm or more, the tearing strength or the tensile strength of the release liner (A) is improved. On the other hand, by setting the thickness to 200 μm or less, it is possible to suppress costs.

The above-described release liner (A) can be manufactured by a known or conventional method without particular limitation; for example, the release liner can be manufactured by forming a release layer on the above-described paper-based base material. More specifically, the release liner (A) can be manufactured by forming release layers (release layer (I) and release layer (II)) by performing drying and/or curing after applying (coating) the above-described releasing agent on the above-described paper-based base material.

At the time of the application (coating) of the above-described releasing agent, it is possible to use conventional coating apparatuses (for example, a gravure roll coater, a reverse roll coater, a kiss-roll coater, a deep roll coater, a bar coater, a knife coater, a spray coater, and the like).

The application amount of the above-described releasing agent is not particularly limited; however, 10 g/m² or less (for example, 0.01 to 10 g/m²) is preferable, 0.05 to 5 g/m² is more preferable, and 0.1 to 3 g/m² is even more preferable. By setting the application amount to 0.01 g/m² or more, it is possible to reduce the peeling force of the release liner (A) and the peeling operability is improved. On the other hand, by setting the application amount to 10 g/m² or less, it is possible to suitably protect the pressure-sensitive adhesive layer without the peeling force of the release liner (A) becoming excessively small. In addition, the generation of siloxane gas from the pressure-sensitive adhesive sheet (pressure-sensitive adhesive body) is suppressed. Here, the above-described “application amount of the releasing agent” signifies the “weight per unit area (1 m²) of the release layer”

### Release Liner (B)

It is possible to use a known or conventional release liner as the above-described release liner (B) without being particularly limited. In addition, for example, the release liner (B) may be the release liners exemplified as the previously described release liner (A).

Although not particularly limited, in a case where the double-sided pressure-sensitive adhesive sheet of the present invention is a double separator type double-sided pressure-sensitive adhesive sheet having the release liner (B), it is preferable that the release liner (B) be used as a release liner to be peeled off prior to the release liner (A).

### Pressure-Sensitive Adhesive Body

The above-described pressure-sensitive adhesive body is a pressure-sensitive adhesive body (double-sided pressure-sensitive adhesive body) in which the surfaces of both sides are pressure-sensitive adhesive faces. The above-described pressure-sensitive adhesive body includes at least a pressure-sensitive adhesive layer. The above-described pressure-sensitive adhesive body may be a “substrate-less pressure-sensitive adhesive body” which does not include a substrate (substrate layer) or may be a “pressure-sensitive adhesive body including a substrate” which includes a substrate. Examples of the above-described substrate-less pressure-sensitive adhesive body include a pressure-sensitive adhesive body (double-sided pressure-sensitive adhesive body) formed only from a pressure-sensitive adhesive layer, or the like. Meanwhile, examples of the pressure-sensitive adhesive body including a substrate include a pressure-sensitive adhesive body (double-sided pressure-sensitive adhesive body including a substrate) including a pressure-sensitive adhesive layer on the surfaces of both sides of the substrate. Here, the double-sided pressure-sensitive adhesive body including a substrate may include the same pressure-sensitive adhesive layers provided on both sides of the substrate, or may include different pressure-sensitive adhesive layers.

### (Pressure-Sensitive Adhesive Layer)

The pressure-sensitive adhesive for forming the pressure-sensitive adhesive layer in the above-described pressure-sensitive adhesive body is not particularly limited and it is possible to use known pressure-sensitive adhesives such as, for example, acrylic pressure-sensitive adhesives, rubber-based pressure-sensitive adhesives, vinyl alkyl ether-based pressure-sensitive adhesives, silicone-based pressure-sensitive adhesives, polyester-based pressure-sensitive adhesives, polyamide-based pressure-sensitive adhesives, urethane-based pressure-sensitive adhesives, fluorine-based pressure-sensitive adhesives, and epoxy-based pressure-sensitive adhesives. The above-described pressure-sensitive adhesives can be used alone or in combination of two or more types. Here, the above-described pressure-sensitive adhesive may take any form, for example, it is possible to use an emulsion type pressure-sensitive adhesive, a solvent type (solution type) pressure-sensitive adhesive, an active energy ray curable type pressure-sensitive adhesive, a thermofusion type pressure-sensitive adhesive (hot melt type pressure-sensitive adhesive), or the like.

Among these, as the pressure-sensitive adhesive for forming the above-described pressure-sensitive adhesive, from the viewpoint of freedom of design, an acrylic pressure-sensitive adhesive is preferable. In other words, the above-described pressure-sensitive adhesive body preferably includes a pressure-sensitive adhesive layer (acrylic pressure-sensitive adhesive layer) formed from an acrylic pressure-sensitive adhesive. Furthermore, the acrylic pressure-sensitive adhesive layer is preferably a pressure-sensitive adhesive layer formed from a pressure-sensitive adhesive composition (acrylic pressure-sensitive adhesive composition) containing an acrylic polymer as an essential component. The content of the acrylic polymer in the above-described acrylic pressure-sensitive adhesive layer (100 wt %) is not particularly limited; however, 50 wt % or more (for example, 50 to 100 wt %) is preferable, 55 to 95 wt % is more preferable, 60 to 90 wt % is even more preferable, and 65 to 85 wt % is particularly preferable.

The above-described acrylic polymer is preferably an acrylic polymer configured with a (meth)acrylate alkyl ester (alkyl(meth)acrylate) having a linear or branched chain alkyl group as an essential monomer component (monomer component). In addition, in the monomer component configuring the above-described acrylic polymer, a polar group-containing monomer, a polyfunctional monomer, or other copolymerizable monomers may be further included as the copolymerizable monomer component. By using these copolymerizable monomer components, for example, it is possible to improve the adhesion force to the adherend, increase the cohesive force of the pressure-sensitive adhesive layer, or the like. Here, the above-described “(meth)acryl” represents “acryl” and/or “methacryl” (any one or both from among “acryl” and “methacryl”) and the same applies elsewhere.

Examples of the above-described (meth)acrylate alkyl ester (below, sometimes simply referred to as “(meth)acrylate alkyl ester”) having a linear or branched chain alkyl group include (meth)acrylate alkyl esters with an alkyl group having 1 to 20 carbon atoms such as methyl (meth)acrylate, ethyl (meth)acrylate, propyl(meth)acrylate, isopropyl(meth)acrylate, n-butyl (meth)acrylate, isobutyl(meth)acrylate, s-butyl (meth)acrylate, t-butyl (meth)acrylate, pentyl(meth)acrylate, isopentyl(meth)acrylate, hexyl(meth)acrylate, heptyl(meth)acrylate, octyl(meth)acrylate, 2-ethyl hexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. The above-described (meth)acrylate alkyl esters may be used alone or in combination of two or more types. Among those described above, (meth)acrylate alkyl esters with an alkyl group having 2 to 10 carbon atoms are preferable, and 2-ethylhexyl acrylate (2EHA) and n-butyl acrylate (BA) are more preferable.

The content of the above-described (meth)acrylate alkyl ester is not particularly limited; however, with respect to the total amount (100 wt %) of the monomer component(s) configuring the acrylic polymer, 50 wt % or more (for example, 50 to 99 wt %) is preferable, 80 to 98 wt % is more preferable, and 85 to 98 wt % is even more preferable. By setting the content to 50 wt % or more, the characteristics (adhesiveness and the like) of the acrylic polymer can be easily exhibited.

Examples of the above-described polar group-containing monomer include carboxyl group-containing monomers (also including acid anhydride group-containing monomers such as maleic anhydride, and itaconic anhydride) such as (meth)acrylate, itaconic acid, maleic acid, fumaric acid, crotonic acid, and isocrotonic acid; hydroxyalkyl(meth)acrylates such as 2-hydroxyethyl(meth)acrylate, 3-hydroxypropyl(meth)acrylate, 4-hydroxybutyl(meth)acrylate, and 6-hydroxyhexyl(meth)acrylate; hydroxyl group-containing monomers such as vinyl alcohol and aryl alcohol; amide group-containing monomers such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethylacrylamide; amino group-containing monomers such as aminoethyl(meth)acrylate, dimethyl aminoethyl(meth)acrylate, and t-butyl aminoethyl(meth)acrylate; glycidyl group-containing monomers such as glycidyl(meth)acrylate and methyl glycidyl(meth)acrylate; cyano group-containing monomers such as acrylonitrile or methacrylonitrile; heterocycle-containing vinyl-based monomers such as N-vinyl-2-pyrrolidone, (meth)acryloyl morpholine, or vinyl pyridine, N-vinyl piperidone, vinyl pyrimidine, N-vinyl piperazine, N-vinyl pyrrole, N-vinyl imidazole, and vinyl oxazole; alkoxyalkyl(meth)acrylate-based monomers such as methoxyethyl(meth)acrylate, and ethoxyethyl(meth)acrylate; sulfonate group-containing monomers such as sodium vinyl sulfonate; phosphate group-containing monomers such as 2-hydroxyethylacryloylphosphate; imide containing monomers such as cyclohexylmaleimide, and isopropyl maleimide; isocyanate group-containing monomers such as 2-methacryloyloxyethylisocyanate; and the like. Here, the above-described polar group-containing monomer can be used alone or in a combination of two or more types. Among the above, as the polar group-containing monomer, a carboxyl group-containing monomer is preferable, and an acrylic acid (AA) is more preferable.

The content of the above-described polar group-containing monomer is not particularly limited; however, with respect to the total amount (100 wt %) of the monomer components configuring the acrylic polymer, 1 to 50 wt % is preferable, 2 to 20 wt % is more preferable, and 2 to 15 wt % is even more preferable. By setting the content of the polar group-containing monomer to 1% or more, the cohesive force is improved. On the other hand, by setting the content of the polar group-containing monomer to 50% or less, the adhesive force is improved without the pressure-sensitive adhesive layer becoming excessively hard.

The above-described polyfunctional monomer is a monomer having two or more ethylenically unsaturated groups (organic group including a carbon-carbon double bond) in the molecule (in one molecule). The above-described ethylenically unsaturated groups are not particularly limited; however, examples thereof include (meth)acryloyl groups, alkenyl groups (vinyl groups (an ethenyl group), allyl groups (a 2-propenyl group), butenyl groups, pentenyl groups, hexyenyl groups, or the like), and the like. Specific examples of the above-described polyfunctional monomers include hexanedioldi(meth)acrylate, butanedioldi(meth)acrylate, (poly)ethyleneglycoldi(meth)acrylate, (poly)propyleneglycoldi(meth)acrylate, neopentylglycoldi(meth)acrylate, pentaerythritoldi(meth)acrylate, pentaerythritoltri(meth)acrylate, dipentaerythritolhexa(meth)acrylate, trimethylolpropanetri(meth)acrylate, tetramethylolmethanetri(meth)acrylate, allyl(meth)acrylate, vinyl(meth)acrylate, divinyl benzene, epoxy acrylate, polyester acrylate, urethane acrylate, and the like.

The content of the above-described polyfunctional monomer is not particularly limited; however, with respect to the total content (100 wt %) of the monomer component configuring the acrylic polymer, 0.5 wt % or less (for example, 0 to 0.5 wt %) is preferable, and 0 to 0.3 wt % is more preferable. By setting the content of the polyfunctional monomer to 0.5 wt % or less, the adhesive force is improved without excessively increasing the cohesive force of the pressure-sensitive adhesive layer. Here, in a case where a cross-linking agent is used, a polyfunctional monomer need not be used; however, in a case where a cross-linking agent is not used, the content of the polyfunctional monomer with respect to the total amount (100 wt %) of the monomer components configuring the acrylic polymer is preferably 0.001 to 0.5 wt % and more preferably 0.002 to 0.1 wt %.

In addition, examples of copolymerizable monomers other than the above-described polar group-containing monomers or the above-described polyfunctional monomers include (meth)acrylate esters having an alicyclic hydrocarbon group such as cyclopentyl(meth)acrylate, cyclohexyl(meth)acrylate, and isobornyl(meth)acrylate; (meth)acrylate aryl esters such as phenyl(meth)acrylate; vinyl esters such as vinyl acetate and vinyl propionate; aromatic vinyl compounds such as styrene, and vinyl toluene; olefins and dienes such as ethylene, butadiene, isoprene, and isobutylene; vinyl ethers such as vinyl alkyl ether; vinyl chloride, and the like.

The above-described acrylic polymer can be polymerized and produced using a known or conventional polymerization method for the above-described monomer components. Examples of the polymerization method of the acrylic polymer include a solution polymerization method, an emulsion polymerization method, a block polymerization method, a polymerization method using the irradiation of active energy rays (active energy ray polymerization method), and the like. Among these, in terms of transparency, water resistance, cost, and the like, the solution polymerization method and the active energy ray polymerization method are preferable, and the solution polymerization method is more preferable.

In the above-described solution polymerization, it is possible to use various types of ordinary solvent. Examples of such solvents (polymerization solvents) include organic solvents such as esters such as ethyl acetate, and n-butyl acetate; aromatic hydrocarbons such as toluene and benzene; aliphatic hydrocarbons such as n-hexane and n-heptane; alicyclic hydrocarbons such as cyclohexane, and methylcyclohexane; ketones such as methylethyl ketone, and methylisobutylketone. The solvents can be used alone, or in a combination of two or more types.

The polymerization initiator or the like used in the polymerization of the above-described acrylic polymer is not particularly limited and it is possible to appropriately select and use one from among those which are known and conventional. More specifically, preferable examples of the polymerization initiator include oil-soluble polymerization initiators such as azo-based polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), and dimethyl-2,2′-azobis(2-methylpropionate); peroxide-based polymerization initiators or the like such as benzoyl peroxide, t-butylhydroperoxide, di-t-butylperoxide, t-butylperoxybenzoate, dicumylperoxide, 1,1-bis(t-butylperoxy)-3,3,5-trimethylcyclohexane, and 1,1-bis(t-butylperoxy)cyclododecane. The polymerization initiators can be used alone or in a combination of two or more types. The use amount of the polymerization initiator is not particularly limited as long as it is within a range which can conventionally be used as a polymerization initiator.

The weight average molecular weight (Mw) of the above-described acrylic polymer is not particularly limited; however, 400,000 to 1,500,000 is preferable, 450,000 to 1,400,000 is more preferable, and 500,000 to 1,300,000 is even more preferable. By setting the weight average molecular weight of the acrylic polymer to 400,000 or more, the cohesive force is improved. On the other hand, by setting the weight average molecular weight of the acrylic polymer to 1,500,000 or less, the coatability is improved. Here, the weight average molecular weight of the acrylic polymer can be controlled according to the type or usage amount of the polymerization initiator, the temperature or time during polymerization, the monomer concentration, the monomer drip rate, and the like.

The above-described weight average molecular weight can be measured using a gel permeation chromatography (GPC) method. Specifically, for example, measurement can be performed with the following method and conditions.

(Sample Production Method)

After dissolving the acrylic polymer in the following eluate to obtain a 0.1% DMF solution and leaving this to stand for one day, filtering is performed through a 0.45 μm membrane filter, and GPC measurement is performed on the filtrate.

(Measurement Conditions)

GPC apparatus: HLC-8120GPC (manufactured by Tosoh Co., Ltd.)

Columns: TSKgel superAWM-H, TSKgel superAW4000, TSKgel superAW2500 (manufactured by Tosoh Co., Ltd.)

Column size: Each 6 mmφ×15 cm, total 45 cm

Column temperature: 40° C.

Eluate: 10 mM-LiBr, 10 mM-phosphate/DMF

Flow rate: 0.4 mL/min

Entrance pressure: 4.6 MPa

Injection amount: 20 μL

Detector: differential refractometer

Standard sample: polyethyleneoxide

Data processing apparatus: GPC-8020 (manufactured by Tosoh Co., Ltd.)

The above-described pressure-sensitive adhesive layer (or the pressure-sensitive adhesive composition for forming the pressure-sensitive adhesive layer) is not particularly limited; however, it preferably contains a cross-linking agent. By using the cross-linking agent, the base polymer (for example, the acrylic polymer) configuring the pressure-sensitive adhesive layer is cross-linked, and the cohesive force of the pressure-sensitive adhesive layer can be made even greater. The above-described cross-linking agent can be appropriately selected from among known and conventional agents and used and is not particularly limited. Specifically, for example, a polyfunctional melamine compound (melamine-based cross-linking agent), a polyfunctional epoxy compound (epoxy-based cross-linking agent), a polyfunctional isocyanate compound (isocyanate-based cross-linking agent), and the like may be preferably used. The above-described cross-linking agents can be used alone, or in a combination of two or more types. Among the above, from the viewpoint of reactivity, an isocyanate-based cross-linking agent and an epoxy-based cross-linking agent are preferable, and the epoxy-based cross-linking agent is more preferable. These cross-linking agents can be used alone, or in a combination of two or more types.

Examples of the above-described isocyanate-based cross-linking agent include lower aliphatic polyisocyanates such as 1,2-ethylenediisocyanate, 1,4-butylenediisocyanate, and 1,6-hexamethylenediisocyanate; alicyclic polyisocyanates such as cyclopentylenediisocyanate, cyclohexylenediisocyanate, isophoronediisocyanate, hydrogenated tolylenediisocyanate, and hydrogenated xylenediisocyanate; aromatic polyisocyanates such as 2,4-tolylenediisocyanate, 2,6-tolylenediisocyanate, 4,4′-diphenylmethanediisocyanate, and xylylenediisocyanate, and in addition, an adduct of trimethylol propane/tolylenediisocyanate (manufactured by Nippon Polyurethane Industry Co., Ltd.; trade name: “CORONATE L”), and an adduct of trimethylolpropane/hexamethylene diisocyanate (manufactured by Nippon Polyurethane Industry Co., Ltd.; trade name: “CORONATE HL”), and the like may also be used.

Examples of the above-described epoxy-based cross-linking agent include N,N,N′,N′-tetraglycidyl m-xylenediamine, diglycidyl aniline, 1,3-bis(N,N-diglycidylaminomethyl)-cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl)isocyanurate, resorcinol diglycydl ether and bisphenol S-diglycidyl ether, as well as epoxy-based resins or the like having two or more epoxy groups in the molecule. As commercial products, for example, trade name “TETRAD C” (manufactured by Mitsubishi Gas Chemical Company, Inc.) can be used.

The content of the cross-linking agent in the above-described pressure-sensitive adhesive layer (or the pressure-sensitive adhesive composition for forming the pressure-sensitive adhesive layer) is not particularly limited; however, with respect to 100 parts by weight of the above-described acrylic polymer, 0.02 to 0.1 parts by weight is preferable, and 0.03 to 0.08 parts by weight is more preferable. Here, for example, the content of the cross-linking agent may be 0.02 to 0.1 parts by weight (more preferably 0.03 to 0.08 parts by weight) with respect to 100 parts by weight of the base polymer configuring the pressure-sensitive adhesive layer. By setting the content to 0.02 parts by weight or more, the cohesive force of the pressure-sensitive adhesive layer is improved. On the other hand, by setting the content to 0.1 parts by weight or less, the adhesion force is improved without the pressure-sensitive adhesive layer becoming excessively hard.

In addition, the above-described pressure-sensitive adhesive layer (or the pressure-sensitive adhesive composition for forming the pressure-sensitive adhesive layer) preferably contains a tackifying resin (tackifier) from the viewpoint of improving adhesiveness. Examples of the above-described tackifying resin include a terpene-based tackifying resin, a phenol-based tackifying resin, a rosin-based tackifying resin, an oil-based tackifying resin, and the like. Among the above, the terpene-based tackifying resin and the rosin-based tackifying resin are preferable. These tackifying resins can be used alone, or in a combination of two or more types.

Examples of the above-described terpene-based tackifying resin include terpene-based resins such as α-pinene polymer, β-pinene polymer, and dipentene polymer; modified terpene-based resins in which these terpene-based resins are modified (phenol-modified, aromatic-modified, hydrogen addition-modified, hydrocarbon-modified, or the like) (for example, terpene phenol-based resins (terpene-based resin having a phenolic hydroxyl group), styrene-modified terpene-based resin, aromatic-modified terpene-based resin, hydrogen added terpene-based resin, or the like); and the like. Here, the phenolic hydroxyl group refers to a hydroxyl group (hydroxyl group) directly bonded to a carbon atom configuring an aromatic ring.

Examples of the above-described phenol-based tackifying resin include condensates of various types of phenols (for example, phenol, m-cresol, 3,5-xylenol, p-alkyl phenol, resorcin, and the like) and formaldehyde (for example, alkyl phenol-based resins, xylene formaldehyde-based resins, or the like); resol in which the above-described phenols and formaldehyde are addition reacted in an alkali catalyst; novolak obtained by condensation reacting the above-described phenols and formaldehyde in an acid catalyst; and rosin-modified phenol resin obtained by thermal polymerization in which phenol is added to rosin (unmodified rosin, modified rosin, various types of rosin derivatives, or the like) in an acid catalyst.

Examples of the above-described rosin-based tackifying resins include unmodified rosins (raw rosin) such as gum rosin, wood rosin, and tall oil rosin; modified rosins in which these unmodified rosins are modified by hydrogenation, disproportionation, polymerization, or the like (hydrogenated rosin, disproportionated rosin, polymerized rosin, other chemically modified rosins, and the like); various types of rosin derivatives; and the like. Here, examples of the above-described rosin derivatives include phenol-modified rosin-based resins (rosin-modified phenol-based resins) in which rosin is modified with phenol by thermal polymerization in which phenol is added to unmodified rosin or modified rosin (hydrogenated rosin, disproportionated rosin, polymerized rosin, and the like) in an acid catalyst; rosin esters such as ester compounds in which unmodified rosin is esterified with alcohols and ester compounds in which modified rosin such as hydrogenated rosin, disproportionated rosin, and polymerized rosin is esterified with alcohols; unsaturated fatty acid-modified rosins in which unmodified rosin or modified rosin (hydrogenated rosin, disproportionated rosin, polymerized rosin, and the like) is modified with an unsaturated fatty acid; unsaturated fatty acid-modified rosin esters in which a rosin ester is modified with an unsaturated fatty acid; rosin alcohols in which a carboxyl group is reduction processed in unmodified rosin, modified rosin (hydrogenated rosin, disproportionated rosin, polymerized rosin, and the like), unsaturated fatty acid-modified rosin, or unsaturated fatty acid-modified rosin ester; metal salts of rosins (in particular, rosin esters) such as unmodified rosin, modified rosin, or various types of rosin derivatives; or the like.

As the above-described oil-based tackifying resin, it is possible to use well-known petroleum resins such as aromatic-based petroleum resin, aliphatic-based petroleum resin, alicyclic-based petroleum resin (aliphatic cyclic-based petroleum resin), aliphatic and aromatic-based petroleum resin, aliphatic and alicyclic-based petroleum resin, hydrogen added petroleum resin, coumarone-based resin, and coumarone indene-based resin. More specifically, examples of the aromatic-based petroleum resin include a polymer using only one species or two or more species of vinyl group-containing aromatic hydrocarbons (for example, styrene, o-vinyltoluene, m-vinyltoluene, p-vinyltoluene, α-methylstyrene, β-methylstyrene, indene, and methylindene, or the like) having 8 to 10 carbon atoms. As the aromatic-based petroleum resin, an aromatic-based petroleum resin (commonly called “C9 based petroleum resin”) obtained from a fraction (commonly called “C9 petroleum fraction”) such as vinyl toluene and indene can be suitably used. In addition, examples of the aliphatic-based petroleum resin include a polymer using only one species or two or more species of olefins or dienes having 4 to 5 carbon atoms (olefins such as butene-1, isobutylene and pentene-1; and dienes such as butadiene, piperylene (1,3-pentadiene) and isoprene). As the aliphatic-based petroleum resin, an aliphatic-based petroleum resin (commonly called “C4 based petroleum resin”, “C5 based petroleum resin”, or the like) obtained from a fraction (commonly called “C4 petroleum fraction”, “C5 petroleum fraction”, or the like) such as butadiene, piperylene and isoprene can be suitably used. Examples of the alicyclic-based petroleum resin include an alicyclic hydrocarbon-based resin polymerized after cyclizing and dimerizing an aliphatic-based petroleum resin (commonly called “C4 petroleum resin”, “C5 petroleum resin”, or the like); a polymer of a cyclic diene compound (cyclopentadiene, dicyclopentadiene, ethylidene norbornene, dipentene, ethylidene bicycloheptene, vinylcycloheptene, tetrahydroindene, vinylcyclohexene, limonene, or the like) or a hydrogen added product thereof; and an alicyclic hydrocarbon-based resin in which hydrogen is added to the aromatic ring of the above-described aromatic-based hydrocarbon resin or the aliphatic and aromatic-based petroleum resin described below; or the like. Examples of the aliphatic and aromatic-based petroleum resin include a styrene olefin-based copolymer, or the like. As the aliphatic and aromatic-based petroleum resin, one commonly called “C5/C9 copolymer-based petroleum resin” or the like can be used.

The above-described tackifying resin preferably has a phenolic hydroxyl group from the viewpoint of the anti-repulsion property after reflow.

Regarding the above-described phenolic hydroxyl group value, the amount of the phenolic hydroxyl group included in 1 g of the tackifying resin having the phenolic hydroxyl group is represented by the amount (mg) of potassium hydroxide required in order to neutralize the acetic acid bonded with the phenolic hydroxyl group during the acetylation of the above-described phenolic hydroxyl group. Accordingly, the phenolic hydroxyl group value is a reference for the amount of the phenolic hydroxyl group present in the tackifying resin having the phenolic hydroxyl group. The above-described phenolic hydroxyl group value can be measured according to JIS K0070.

It is possible to use a commercial product as the above-described tackifying resin, for example, trade name “TAMANOL 803L” (manufactured by Arakawa Chemical Industries, phenol-modified rosin-based resin), trade name “YS POLYSTER S145” (manufactured by Yasuhara Chemical Co., Ltd., terpene phenol-based resin), and the like can be used.

The content of the tackifying resin in the above-described pressure-sensitive adhesive layer (or the pressure-sensitive adhesive composition for forming the pressure-sensitive adhesive layer) is not particularly limited; however, with respect to 100 parts by weight of the above-described acrylic polymer, more than 0 parts by weight to 60 parts by weight or less is preferable, 5 to 50 parts by weight is more preferable, and 10 to 45 parts by weight is even more preferable. Here, for example, with respect to 100 parts by weight of the base polymer configuring the pressure-sensitive adhesive layer, the content of the tackifying resin may be more than 0 parts by weight to 60 parts by weight or less (5 to 50 parts by weight is more preferable, and 10 to 45 parts by weight is even more preferable). By setting the content to exceed 0, the adhesion force is improved. On the other hand, by setting the content to 60 parts by weight or less, the cohesive force of the pressure-sensitive adhesive layer is improved.

In addition, as necessary, the above-described pressure-sensitive adhesive layer (or the pressure-sensitive adhesive composition for forming the pressure-sensitive adhesive layer) may contain known additives such as cross-linking accelerators, antioxidants, fillers, colorants (dyes, pigments, or the like), ultraviolet ray absorbers, chain transfer agents, plasticizers, curing agents, surfactants, and antistatic agents, or solvents (solvents or the like usable during solution polymerization of the acrylic polymer described above).

The thickness of the above-described pressure-sensitive adhesive layer is not particularly limited; however, 10 to 70 μm is preferable, 15 to 65 μm is more preferable, and 20 to 60 μm is even more preferable. By setting the thickness to 10 μm or more, the stress generated at the times of sticking is easier to disperse, and peeling is less easily generated. On the other hand, by setting the thickness to 70 μm or less, there is an advantage in terms of miniaturization and thinning of the product.

The gel fraction of the above-described pressure-sensitive adhesive layer is not particularly limited; however, 20 to 70% (wt %) is preferable, and 28 to 65% is more preferable. The above-described gel fraction can be determined as ethyl acetate insoluble matter, more specifically, determined as a weight fraction (unit: wt %) of the insoluble components after the pressure-sensitive adhesive layer is immersed for 7 days at 23° C. in ethyl acetate, with respect to the sample before immersion. By setting the gel fraction to 20% or more, the cohesive force of the pressure-sensitive adhesive layer is improved. On the other hand, by setting the gel fraction to 70% or less, the adhesion force is improved without the pressure-sensitive adhesive layer becoming excessively hard.

Specifically, the above-described gel fraction (ratio of solvent insoluble portion) is a value calculated by the following “gel fraction measurement method”, for example.

(Gel Fraction Measurement Method)

After extracting approximately 0.1 g of a pressure-sensitive adhesive layer from the double-sided pressure-sensitive adhesive sheet of the present invention and performing covering with a porous tetrafluoroethylene sheet (trade name “NTF 1122” manufactured by Nitto Denko Corporation) having an average hole diameter of 0.2 μm, tying is performed with a kite string, the weight at that time is measured and this weight is set as the weight before immersion. Here, the weight before immersion is the total weight of the pressure-sensitive adhesive layer (the pressure-sensitive adhesive layer extracted in the above description), the tetrafluoroethylene sheet, and the kite string. In addition, the total weight of the tetrafluoroethylene sheet and the kite string is measured in advance, and this weight is set as the weight of the wrapping.

Next, the pressure-sensitive adhesive layer wrapped with a tetrafluoroethylene sheet and tied up with a kite string (referred to as the “sample”) is put in a 50 ml vessel filled with ethyl acetate, and left to stand at 23° C. for 7 days. Subsequently, the sample (after ethyl acetate treatment) is then taken out of the vessel, transferred to an aluminum cup, and dried in a dryer at 130° C. for 2 hours to remove the ethyl acetate, after which the weight is measured, and this weight is set as the weight after immersion.

Then, the gel fraction is calculated from the following formula.

Gel fraction(wt %)=(A−B)/(C−B)×100

(In the above-described formula, A is the weight after immersion, B is the weight of the wrapping, and C is the weight before immersion.)

Here, the above-described gel fraction can be controlled by, for example, the monomer composition or weight average molecular weight of the acrylic polymer, or the usage amount (addition amounts) of the cross-linking agent.

### (Substrate)

The substrate is not particularly limited; however, for example, it is possible to use a fiber-based substrate such as cloth, non-woven fabric, felt, and net; a paper-based substrate such as various types of paper; a metal-based substrate such as metal foil or a metal plate; a plastic-based substrate such as a film or a sheet formed of various types of resin (polyolefin-based resin, polyester-based resin, polyvinyl chloride-based resin, polyvinyl acetate-based resin, polyamide-based resin, polyimide-based resin, polyetheretherketone, polyphenylenesulfide, and the like); a rubber-based substrate such as a rubber sheet; a foam body such as a foam sheet, or a suitable thin laminate body such as a laminated body of the above materials. Here, the above-described substrate may have a single layer form, or may have a multilayer form.

As the above-described substrate, from the viewpoint of the anchoring of the pressure-sensitive adhesive layer, costs, and the like, the fiber-based substrate is preferable, among which the non-woven fabric is more preferable. As the non-woven fabric, non-woven fabric of natural fibers can be preferably used, among which non-woven fabric including Manila hemp (Manila hemp-based non-woven fabric) is more preferable.

The thickness of the above-described substrate is not particularly limited; however, 5 to 40 μm is preferable, 10 to 30 μm is more preferable, and 10 to 20 μm is even more preferable. By setting the thickness to 5 μm or more, the strength of the pressure-sensitive adhesive sheet is improved. On the other hand, by setting the thickness to 40 μm or less, there is an advantage in terms of miniaturization and thinning of the product.

In a case where the above-described substrate is a non-woven fabric, the basis weight of the non-woven fabric is not particularly limited; however, 5 to 15 g/m² is preferable, and 6 to 10 g/m² is more preferable. By setting the basis weight to 5 g/m² or more, the strength of the pressure-sensitive adhesive sheet is improved. On the other hand, by setting the basis weight to 15 g/m² or less, it becomes easier to control the thickness of the substrate in the above-described range.

Here, the strength of the above-described substrate is not particularly limited; however, the tensile strength of the longitudinal direction (MD) is preferably 2 N/15 mm or more, and more preferably 5 N/15 mm or more. Here, the tensile strength can be measured according to JIS P8113.

According to necessity, in order to increase the adhesiveness with the pressure-sensitive adhesive layer, a known or conventional surface treatment may be carried out on the surface of the above-described base material, for example, such as chromic acid treatment, ozone exposure, flame exposure, high pressure shock exposure, oxidation treatment or the like according to a chemical or physical method of ionization radiation processing, or a coating process or the like may be carried out using a priming agent.

Within a range not deteriorating the effect of the present invention, the above-described pressure-sensitive adhesive body may have other layers (for example, an intermediate layer, a primer layer, or the like) as well as the above-described pressure-sensitive adhesive layer and the above-described substrate.

The thickness of the above-described pressure-sensitive adhesive body is not particularly limited; however, 10 to 70 μm is preferable, 15 to 65 μm is more preferable, and 20 to 60 μm is particularly preferable. By setting the thickness to 10 μm or more, the stress generated at the times of sticking is easier to disperse, and peeling is less easily generated. On the other hand, by setting the thickness to 70 μm or less, there is an advantage in terms of miniaturization and thinning of the product.

The forming method of the above-described pressure-sensitive adhesive body is not particularly limited; however, examples thereof can include methods of applying (coating) the above-described pressure-sensitive adhesive composition on the substrate or the release liner, drying and/or curing according to necessity, and forming the pressure-sensitive adhesive layer.

Here, in the application (coating) in the method of forming the above-described pressure-sensitive adhesive layer, it is possible to use a known coating method, and it is possible to use a conventional coater, for example, a gravure roll coater, a reverse roll coater, a kiss-roll coater, a deep roll coater, a bar coater, a knife coater, a spray coater, a comma coater, a direct coater, or the like.

### Double-Sided Pressure-Sensitive Adhesive Sheet

The double-sided pressure-sensitive adhesive sheet of the present invention has a release liner (A) on a pressure-sensitive adhesive face (a). In other words, the double-sided pressure-sensitive adhesive sheet of the present invention is provided with a release liner (A) on a pressure-sensitive adhesive face (a) such that a release layer (I) of the above-described release liner (A) and a pressure-sensitive adhesive face (a) of the above-described pressure-sensitive adhesive body come into contact with each other.

In a case where the double-sided pressure-sensitive adhesive sheet of the present invention is a double separator type double-sided pressure-sensitive adhesive sheet having a release liner (A) on the pressure-sensitive adhesive face (a) of the adhesive body and a release liner (B) on the pressure-sensitive adhesive face (b), the release liner (A) is preferably a release liner peeled off after the release liner (B) is peeled off.

The double-sided pressure-sensitive adhesive sheet of the present invention has a release liner (A) in which the ratio of the interlayer strength of the release liner (A) with respect to the peeling force of the release liner (A) in the peeling test at 90° with respect to the pressure-sensitive adhesive face (a) is 15 or more. Therefore, when the release liner (A) is peeled off from the pressure-sensitive adhesive body, the peeling operability is excellent since defects such as the release liner (A) being interlaminarly ripped and torn, or parts of the release liner (A) interlaminarly ripped being left in the pressure-sensitive adhesive body are less likely to occur.

The double-sided pressure-sensitive adhesive sheet of the present invention can be produced using a known or conventional method and is not particularly limited; however, for example, in a case where the pressure-sensitive adhesive body in the double-sided pressure-sensitive adhesive sheet of the present invention does not contain a substrate, for instance, it is possible to implement the production by forming the pressure-sensitive adhesive layer on the release layer (I) of the release liner (A). On the other hand, in a case where the pressure-sensitive adhesive body in the double-sided pressure-sensitive adhesive sheet of the present invention does contain a substrate, for instance, the pressure-sensitive adhesive layer may be directly formed on the surface of the above-described substrate (direct copying method), or the pressure-sensitive adhesive layer may be provided on the substrate by transferring (pasting) onto the above-described substrate after the pressure-sensitive adhesive layer is formed on the release layer (I) of the release liner (A) (transfer method).

(Double-Sided Pressure-Sensitive Adhesive Sheet with Pull Tab Attached)

From the viewpoint of peeling operability, the double-sided pressure-sensitive adhesive sheet of the present invention is preferably a pressure-sensitive adhesive sheet with a pull tab attached (pull tab processed double-sided pressure-sensitive adhesive sheet). The above-described pull tab (pull tab for peeling) refers to a portion used as a gripping part during peeling of the release liner from the double-sided pressure-sensitive adhesive sheet, and the inclusion of the above-described pull tab facilitates the peeling of the release liner.

Normally, the above-described pull tab is configured by a portion (this portion does not come into contact with the pressure-sensitive adhesive body) in which one part of the outer circumference of the release liner in the pressure-sensitive adhesive sheet is made to protrude from the pressure-sensitive adhesive body. In particular, the above-described pull tab is preferably a pull tab formed by making at least a part of the release liner (A) protrude from the pressure-sensitive adhesive body. Specifically, for example, the pull tab in the double-sided pressure-sensitive adhesive sheet of the present invention is preferably a pull tab formed by making a part or the whole of the longitudinal direction of the release liner (A) protrude from the pressure-sensitive adhesive body.

The size of the above-described pull tab is not particularly limited; however, generally, from the viewpoint of ease of gripping during the peeling operation or the like, as shown in FIG. 1, the pull tab is preferably formed in a shape having a narrower width than the width of the double-sided pressure-sensitive adhesive sheet. In addition, the position at which the pull tab is formed and the number of pull tabs can be appropriately selected according to the circumstances of use of the double-sided pressure-sensitive adhesive sheet, without being particularly limited.

FIG. 1 is a schematic diagram (plan view) representing one embodiment of the double-sided pressure-sensitive adhesive sheet of the present invention with a pull tab attached (double-sided pressure-sensitive adhesive sheet of the present invention having a pull tab on the release liner (A)). In addition, FIG. 2 is a cross-sectional view of X-X in FIG. 1. In FIG. 1 and FIG. 2, 1 represents the release liner (A), and 12 represents the pull tab (pull tab for peeling). In addition, 2 represents the pressure-sensitive adhesive body, 3 represents the release liner (B), and 4 represents the double-sided pressure-sensitive adhesive sheet with pull tab attached.

In a case where the double-sided pressure-sensitive adhesive sheet of the present invention is a double-sided pressure-sensitive adhesive sheet with a pull tab attached, the peeling of the release liner (A) is facilitated by the inclusion of the pull tab and, even in a case where a slit is added to the release liner (A) during the forming of the pull tab, since problems such as the release liner (A) being interlaminarly ripped and torn are unlikely to occur, even more excellent peeling operability is exhibited.

The pull tab can be formed by a known or conventional method of forming a pull tab (method of pull tab processing) without being particularly limited. Examples of methods of producing the double-sided pressure-sensitive adhesive sheet of the present invention with a pull tab attached include methods such as cutting out only a release liner of one side (release liner (B)) and a double-sided pressure-sensitive adhesive body during processing of punching out a pressure-sensitive adhesive sheet in which release liners are formed on both pressure-sensitive adhesive faces of the double-sided pressure-sensitive adhesive body, and peeling off the cut out release liner (B) and the pressure-sensitive adhesive body (in other words, the above-described pull tab is formed at one part of the release liner (release liner (A)) which is the one that is not cut out).

Here, the double-sided pressure-sensitive adhesive sheet of the present invention may be subjected to half cut processing (may be subjected to half cut processing other than the pull tab processing) in an arbitrary shape (for example, a substantially circular shape, a substantially rectangular shape, or the like) other than at the outer circumferential portion of the double-sided adhesive tape (for example, the center portion or the like of the release liner). In the double-sided pressure-sensitive adhesive sheet of the present invention subjected to half cut processing in an arbitrary shape, even in a case where a slit is added to the release liner (A) during the half cut processing, since problems such as the release liner (A) being interlaminarly ripped and torn are unlikely to occur, excellent peeling operability is exhibited. The above-described half cut processing into an arbitrary shape is carried out with a known or conventional half cut processing method, without being particularly limited.

The double-sided pressure-sensitive adhesive sheet of the present invention is not particularly limited; however, it can be used as a pressure-sensitive adhesive sheet for a flexible printed circuit board (double-sided pressure-sensitive adhesive sheet for use in a fixing application of a flexible printed circuit board) used for the purpose of fixing a flexible printed circuit board (FPC) to an adherend. The adherend to which the FPC is fixed by the double-sided pressure-sensitive adhesive sheet of the present invention is not particularly limited; however, examples thereof include a casing of a cell phone, a motor, a base, a substrate, a cover, or the like. In addition, by using the double-sided pressure-sensitive adhesive sheet of the present invention and pasting and fixing the FPC to the above-described adherend, a hard disk drive, a cell phone, a motor, or the like may be produced.

The above-described FPC is not particularly limited; however, it may include an electrical insulating layer (sometimes referred to as a “base insulating layer”), a conductive material layer (sometimes referred to as a “conductor layer”) formed so as to be a predetermined circuit pattern on the above-described base insulating layer, and, according to necessity, an electrical insulating layer for covering (sometimes referred to as a “cover insulating layer”) provided on the above-described conductor layer. Here, the FPC may have a multilayer structure of a structure in which a plurality of circuit boards are laminated.

The above-described base insulating layer is an electrical insulating layer formed by an electrically insulating material. The electrically insulating material for forming the base insulating layer can be appropriately selected from among electrically insulating material used in known flexible printing circuit boards and used, without being particularly limited. Specifically, preferable examples of the electrical insulating material include polyimide-based resin, acrylic resin, polyether nitrile-based resin, polyether sulfone-based resin, polyester-based resin (polyethylene terephthalate-based resin, polyethylene naphthalate-based resin, and the like), polyvinyl chloride-based resin, polyphenylene sulfide-based resin, polyetheretherketone-based resin, polyamide-based resin (in other words, “aramid resin” and the like), polyarylate-based resin, polycarbonate-based resin, liquid crystal polymers, and the like plastic materials. Here, the electrical insulating material can be used alone or in a combination of two or more types. Among these, polyimide-based resin is preferred. The base insulating layer may have the form of any of a single layer or a laminated body. Various types of surface treatment (for example, corona discharge treatment, plasma treatment, surface roughening treatment, hydrolysis treatment, and the like) may be carried out on the surface of the base insulating layer. The thickness of the base insulating layer is not particularly limited; however, 3 to 100 μm is preferable, 5 to 50 μm is more preferable, and 10 to 30 μm is even more preferable.

The above-described conductor layer is a conductive material layer formed by a conductive material. The conductor layer is formed so as to be a predetermined circuit pattern on the above-described base insulating layer. The conductive material for forming such a conductor layer can be selected from among conductive materials used in known flexible printed circuit boards and used, without being particularly limited. Specifically, examples of the conductive material include metal materials such as copper, nickel, gold, and chromium, as well as various types of alloys (for example, solder), platinum, conductive plastic materials, and the like. Here, the conductive material can be used alone or in a combination of two or more types. Among these, metal materials (in particular, copper) are preferred. The conductor layer may have the form of any of a single layer or a laminated body. Various types of surface treatment may be carried out on the surface of the conductor layer. The thickness of the conductor layer is not particularly limited; however, 1 to 50 μm is preferable, 2 to 30 μm is more preferable, and 3 to 20 μm is even more preferable.

The method of forming the above-described conductor layer can be appropriately selected from known forming methods (for example, known patterning methods such as a subtractive method, an additive method, or a semi-additive method), without being particularly limited. For example, in a case where the conductor layer is formed directly on the surface of the base insulating layer, the conductor layer can be formed using an electroless plating method, an electroplating method, a vacuum deposition method, a sputtering method, or the like to carry out plating, deposition, or the like of the conductive material on the base insulating layer so as to form a predetermined circuit pattern.

The above-described cover insulating layer is an electrical insulating layer for covering (protective electrical insulating layer) formed by an electric insulating material and covering the conductor layer. The cover insulating layer is provided as necessary and it is not essential that the cover insulating layer is always provided. The electrically insulating material for forming the above-described cover insulating layer can be appropriately selected from among electrically insulating material used in known flexible printing circuit boards and used in the same manner as the base insulating layer, without being particularly limited. Specifically, examples of the electrical insulating material for forming the cover insulating layer include the electrical insulating materials and the like exemplified as electrical insulating materials for forming the above-described base insulating layer, and, similarly to the case of the base insulating layer, plastic materials (in particular, polyimide-based resin) are preferred. Here, the electrical insulating material for forming the cover insulating layer can be used alone or in a combination of two or more types. The cover insulating layer may have the form of any of a single layer or a laminated body. Various types of surface treatment (for example, corona discharge treatment, plasma treatment, surface roughening treatment, hydrolysis treatment, and the like) may be carried out on the surface of the cover insulating layer. The thickness of the cover insulating layer is not particularly limited; however, 3 to 100 μm is preferable, 5 to 50 μm is more preferable, and 10 to 30 μm is even more preferable.

The forming method of the above-described cover insulating layer can be appropriately selected from known forming methods (for example, a method of coating and drying a liquid substance or melt including an electrical insulating material, a method of laminating a film or a sheet corresponding to the shape of the conductor layer and formed of an electrical insulating material, or the like) without being particularly limited.

### EXAMPLES

In the followings, more detailed description will be given of the present invention based on Examples; however, the present invention is not limited to these Examples.

### Example 1

### Preparation of Pressure-Sensitive Adhesive Composition

100 parts by weight of butyl acrylate (BA) and 5 parts by weight of acrylic acid (AA) as monomer components of an acrylic polymer, 0.2 parts by weight of benzoyl peroxide as a polymerization initiator, and 240 parts by weight of toluene as a polymerization solvent were charged into a separable flask and stirred for two hours while introducing nitrogen gas. In this manner, after removing the oxygen in the polymerization system, the temperature was increased to 62° C., and the resultant was reacted for seven hours to obtain an acrylic polymer solution having a solid content concentration of 30 wt %. The weight average molecular weight (Mw) of the acrylic polymer was 550,000.

As shown in Table 1, 30 parts by weight of a phenol-modified rosin-based resin (trade name: “TAMANOL 803L,” manufactured by Arakawa Chemical Industries, Ltd., the value of phenolic hydroxyl group: less than 20 mgKOH/g) and 10 parts by weight of a terpene phenol-based resin (trade name: “YS POLYSTER S145”, manufactured by Yasuhara Chemical Co., Ltd., the value of phenolic hydroxyl group: 77 mgKOH/g) as tackifying resins, and 0.05 parts by weight of an epoxy-based cross-linking agent (trade name: “TETRAD C”, manufactured by Mitsubishi Gas Chemical Company, Inc.) as a cross-linking agent were blended with respect to 100 parts by weight of the acrylic polymer in the above-described acrylic polymer solution, and a pressure-sensitive adhesive composition solution (acrylic pressure-sensitive adhesive composition solution) was obtained. Here, the blending amount (parts by weight) of TETRAD C (epoxy-based cross-linking agent) is the blending amount of TETRAD C itself (actual product) with respect to 100 parts by weight of the acrylic polymer.

(Preparation of Release liner)

Glassine paper (trade name: “RRP-70 (T)”, manufactured by Tomoegawa Paper Co., Ltd., thickness 0.070 mm, basis weight 70 g/m²) was used as the liner base material. In addition, as a silicone-based releasing agent, a thermocurable silicone-based releasing agent [mixture of 100 parts by weight of trade name: “X-62-1492”, (manufactured by Shin-Etsu Chemical Co., Ltd.) and 2 parts by weight of trade name: CAT-PL-56” (manufactured by Shin-Etsu Chemical Co., Ltd.)] was used. After the above-described silicone-based releasing agent was coated on one surface of the above-described liner base material with a coating amount (in terms of solid content) of 2.5 g/m² and heated for one minute at 120° C., aging was performed at 50° C. for 72 hours to form a release layer, whereby the release liner was manufactured.

### (Preparation of Double-Sided Pressure-Sensitive Adhesive Sheet)

After the above-described pressure-sensitive adhesive composition was coated on the surface of the above-described release liner (surface of the release layer side), a drying treatment was performed for three minutes at 110° C. and a pressure-sensitive adhesive layer having a thickness of 20 μm was formed. Next, the above-described pressure-sensitive adhesive layer was stuck on each side of a Manila hemp-based non-woven fabric (thickness 18 μm) such that the above-described pressure-sensitive adhesive layer and the surface of the Manila hemp-based non-woven fabric faced each other, and a double-sided pressure-sensitive adhesive sheet in which the thickness (the thickness of a portion other than the release liner in the double-sided pressure-sensitive adhesive sheet, the distance from the surface in which one pressure-sensitive adhesive layer comes into contact with the release liner to the surface in which the other pressure-sensitive adhesive layer comes into contact with the release liner) of the above-described non-woven fabric and the above-described pressure-sensitive adhesive layers provided on both surfaces of the non-woven fabric was 50 μm was obtained.

### Example 2

As shown in Table 1, a double-sided pressure-sensitive adhesive sheet was obtained in the same manner as Example 1, except that a thermocurable silicone-based releasing agent [a mixture of 100 parts by weight of trade name “AST-8” (manufactured by Arakawa Chemical Industries, Ltd., and 7.3 parts by weight of trade name “CATA12070” (manufactured by Bluestar Silicones)] was used as the silicone-based releasing agent.

### Example 3

As shown in Table 1, a double-sided pressure-sensitive adhesive sheet was obtained in the same manner as Example 1, except that a thermocurable silicone-based releasing agent [a mixture of 100 parts by weight of trade name “BY24-4538” (manufactured by Toray Dow Corning Co., Ltd.) and 10 parts by weight of trade name “BY24-490” (manufactured by Toray Dow Corning Co., Ltd.)] was used as the silicone-based releasing agent. Here, the blending amount (parts by weight) of “BY24-4538” and “BY24-490” is the blending amount of “BY24-4538” and “BY24-490” themselves (actual products) with respect to 100 parts by weight of the acrylic polymer.

### Example 4

As shown in Table 1, a double-sided pressure-sensitive adhesive sheet was obtained in the same manner as Example 1, except that a thermocurable silicone-based releasing agent [a mixture of 30 parts by weight of trade name “BY24-489” (manufactured by Toray Dow Corning Co., Ltd.), 70 parts by weight of trade name “BY24-4538” (manufactured by Toray Dow Corning Co., Ltd.), and 10 parts by weight of trade name “BY24-490” (manufactured by Toray Dow Corning Co., Ltd.)] was used as the silicone-based releasing agent. Here, the blending amount (parts by weight) of “BY24-489” is the blending amount of “BY24-489” itself (actual product) with respect to 100 parts by weight of the acrylic polymer.

### Example 5

As shown in Table 1, a double-sided pressure-sensitive adhesive sheet was obtained in the same manner as Example 2, except that glassine paper (trade name: “NSGP-RT100”, manufactured by Oji Specialty Paper Co., Ltd., thickness 0.090 mm, basis weight 100 g/m²) was used as the liner base material.

### Example 6

### Preparation of Pressure-Sensitive Adhesive Composition

An acrylic polymer solution (solid content: 30.0 wt %) including an acrylic polymer was prepared by performing a solution polymerization process on 90 parts by weight of 2-ethylhexyl acrylate (2EHA) and 10 parts by weight of acrylic acid (AA) in 210 parts by weight of ethyl acetate while stirring at 60 to 80° C. in the presence of 0.4 parts by weight of benzoyl peroxide and under nitrogen substitution. The weight average molecular weight (Mw) of the acrylic polymer was 1,200,000.

As shown in Table 1, 20 parts by weight of a terpene phenol-based resin (trade name: “YS POLYSTER S145”, manufactured by Yasuhara Chemical Co., Ltd., softening point 145° C.) as an tackifying resin, and 0.05 parts by weight of a polyfunctional epoxy-based cross-linking agent (trade name: “TETRAD C”, manufactured by Mitsubishi Gas Chemical Company, Inc.) as a cross-linking agent were added to and mixed with respect to 100 parts by weight of the acrylic polymer in the above-described acrylic polymer solution, and a pressure-sensitive adhesive composition (acrylic pressure-sensitive adhesive composition solution) was obtained.

A double-sided pressure-sensitive adhesive sheet was obtained in the same manner as Example 5, except that the above-described pressure-sensitive adhesive composition was used.

### Comparative Example 1

As shown in Table 1, a double-sided pressure-sensitive adhesive sheet was obtained in the same manner as Example 1, except that, as the release liner, trade name: “100GVW (14/12) heat resistance”, manufactured by Oji Specialty Paper Co., Ltd., (thickness 0.092 mm, basis weight 100 g/m²) was used.

### Comparative Example 2

As shown in Table 1, a double-sided pressure-sensitive adhesive sheet was obtained in the same manner as Example 5, except that, as the silicone-based releasing agent, a cation polymerizable ultraviolet ray curable silicone-based releasing agent [mixture of 100 parts by weight of trade name: “X-62-7658”, (manufactured by Shin-Etsu Chemical Co., Ltd.) and 1 part by weight of trade name: CAT-7605″ (manufactured by Shin-Etsu Chemical Co., Ltd., ultraviolet ray cleavage initiator)] was used.

### Comparative Example 3

As shown in Table 1, a double-sided pressure-sensitive adhesive sheet was obtained in the same manner as Comparative Example 2, except that, as the pressure-sensitive adhesive composition, the pressure-sensitive adhesive composition of Example 6 was used.

### (Evaluation)

With respect to the release liners and the double-sided pressure-sensitive adhesive sheets obtained in the Examples and Comparative Examples, measurement and evaluation were performed according to the following measurement method and evaluation method. The results are shown in Table 2.

### (1) Peeling Force of Release Liner

Measurement samples were produced by cutting out the double-sided pressure-sensitive adhesive sheets obtained in the Examples and the Comparative Examples into strip shaped sheet pieces of width 50 mm×length 150 mm, peeling off one release liner, and pasting (lining) a PET film (trade name: LUMIRROR S10, manufactured by Toray Co., Ltd., thickness 25 μm) on the pressure-sensitive adhesive face from which the release liner was peeled off.

Using a tensile testing machine, a peeling test was performed, and the 90° peeling force (peeling strength) (units: N/50 mm) of the release liner was measured.

The measurement was performed under conditions of 23° C., a 50% RH atmosphere, a peeling angle of 90°, and a tension rate of 300 mm/minute. The number of tests was set to 3 times (n=3), and the average value was set as the “peeling force of the release liner”.

### (2) Interlayer Strength of Release Liner

Measurement samples were produced by pasting silicone tape (trade name: “No. 5302A”, manufactured by Nitto Denko Corporation, one in which a PET film (trade name “S10#25”, manufactured by Toray Co., Ltd.) was lined on an acrylic pressure-sensitive adhesive face) on both sides of each release liner obtained in the Examples and the Comparative Examples, and cutting these into strip shaped sheet pieces of width 50 mm×length 150 mm.

Using a tensile testing machine, a peeling test was performed at 180°, and the 180° peel force (peeling strength) (units: N/50 mm) of the release liner at the time when the release liner was interlaminarly ripped was measured.

The measurement was performed under conditions of 23° C., a 50% RH atmosphere, a peeling angle of 180°, and a tension rate of 300 mm/minute. The number of tests was set to 3 times (n=3), and the average value was set as the “interlayer strength of the release liner”.

Here, “the release liner was interlaminarly ripped” refers to a state where it was visually recognized that the release liner of the evaluation sample was interlaminarly ripped and separated into two or more pieces.

### (3) Interlayer Strength of Release Liner/Peeling Force of Release Liner

The ratio of interlayer strength of release liner/peeling force of release liner was calculated from the “peeling force of release liner (N/50 mm)” measured in the above-described (1) Peeling Force of Release liner and the “interlayer strength of release liner (N/50 mm)” measured in the above-described (2) Interlayer Strength of Release liner.

Here, the ratio of interlayer strength of release liner/peeling force of release liner was calculated from the following formula.

Interlayer strength of release liner/peeling force of release liner=interlayer strength of release liner(N/50 mm)/peeling force of release liner(N/50 mm)

### (4) Processability

The double-sided pressure-sensitive adhesive sheets obtained in the Examples and Comparative Examples were cut out into strip shapes of width 35 mm and length 85 mm. The end portion in the length direction of the strip shaped double-sided pressure-sensitive adhesive sheet was subjected to punching out processing (pull tab processing) in a pressing machine, one release liner and a pressure-sensitive adhesive body were cut, a pull tab having a rectangular shape of width 35 mm and length 25 mm was formed, and a double-sided pressure-sensitive adhesive sheet with pull tab attached was produced. During the punching out processing, a slit was provided in one part of the cut surface by cutting up to the center portion (approximately half the length of the thickness of the release liner) of the release liner forming the pull tab. An evaluation sample was produced by peeling off the release liner in which a pull tab was not formed from the above-described double-sided pressure-sensitive adhesive sheet with a pull tab attached, and pasting the pressure-sensitive adhesive face exposed by the peeling off of the release liner onto the center portion of a PET film (trade name: LUMIRROR S10, manufactured by Toray Co., Ltd., width 210 mm×length 297 mm×thickness 25 μm). After leaving to stand for 30 minutes at room temperature after the pasting, the release liner in which a slitted pull tab was formed was peeled off. The state of the release liner after the peeling was visually recognized, and a case where the base material of the release liner was not interlaminarly ripped from the slit was determined as “not torn” and a case where the base material of the release liner was interlaminarly ripped from the slit was determined as “torn”.

Among the evaluated samples (10 pieces), the number of samples determined as “torn” is shown in the processability column of Table 2 as “torn/number of evaluations (number of samples determined as torn/10)”.

### (5) Gel Fraction

The gel fraction of the pressure-sensitive adhesive layer of the double-sided pressure-sensitive adhesive sheet obtains in the Examples and Comparative Examples was measured according to the above-described “Gel Fraction Measurement Method”.

TABLE 1

| | Pressure-Sensitive Adhesive Composition | | | | | | | | |
|---|---|---|---|---|---|---|---|---|---|
| | Acrylic polymer solution | | | | | | | Cross-linking | |
| | Monomer | | | Tackifying agent | | | | agent | |
| | composition | | Content | | Content | | Content | | Content |
| | ratio of acrylic | | (parts by | | (parts by | | (parts by | | (parts by |
| | polymer | Mw | weight) | Type | weight) | Type | weight) | Type | weight) |
| Example 1 | BA/AA = | 550,000 | 100 | TAMANOL | 30 | YS | 10 | TETRADC | 0.05 |
| | 100/5 | | | 803L | | POLYSTER | | | |
| | | | | | | S145 | | | |
| Example 2 | BA/AA = | 550,000 | 100 | TAMANOL | 30 | YS | 10 | TETRADC | 0.05 |
| | 100/5 | | | 803L | | POLYSTER | | | |
| | | | | | | S145 | | | |
| Example 3 | BA/AA = | 550,000 | 100 | TAMANOL | 30 | YS | 10 | TETRADC | 0.05 |
| | 100/5 | | | 803L | | POLYSTER | | | |
| | | | | | | S145 | | | |
| Example 4 | BA/AA = | 550,000 | 100 | TAMANOL | 30 | YS | 10 | TETRADC | 0.05 |
| | 100/5 | | | 803L | | POLYSTER | | | |
| | | | | | | S145 | | | |
| Example 5 | BA/AA = | 550,000 | 100 | TAMANOL | 30 | YS | 10 | TETRADC | 0.05 |
| | 100/5 | | | 803L | | POLYSTER | | | |
| Example 6 | 2EHA/AA = | 1,200,000 | 100 | | | YS | 20 | TETRADC | 0.05 |
| | 90/10 | | | | | POLYSTER | | | |
| | | | | | | S145 | | | |
| Comparative | BA/AA = | 550,000 | 100 | TAMANOL | 30 | YS | 10 | TETRADC | 0.05 |
| Example 1 | 100/5 | | | 803L | | POLYSTER | | | |
| | | | | | | S145 | | | |
| Comparative | BA/AA = | 550,000 | 100 | TAMANOL | 30 | YS | 10 | TETRADC | 0.05 |
| Example 2 | 100/5 | | | 803L | | POLYSTER | | | |
| | | | | | | S145 | | | |
| Comparative | 2EHA/AA = | 1,200,000 | 100 | | | YS | 20 | TETRADC | 0.05 |
| Example 3 | 90/10 | | | | | POLYSTER | | | |
| | | | | | | S145 | | | |

| | Release liner | | | |
|---|---|---|---|---|
| | Base material | | | |
| | | | Basis | Releasing agent |
| | | Thickness | weight | Type |
| | Type | (mm) | (g/m²) | (Composition ratio) |
| Example 1 | Glassine | 0.070 | 70 | Thermocurable |
| | paper | | | silicone-based |
| | RRP- | | | releasing agent |
| | 70(T) | | | (X-62-1492/CAT- |
| | | | | PL-56 = 100/2) |
| Example 2 | Glassine | 0.070 | 70 | Thermocurable |
| | paper | | | silicone-based |
| | RRP- | | | releasing agent |
| | 70(T) | | | (AST-8/CATA12070 = |
| | | | | 100/7.3) |
| Example 3 | Glassine | 0.070 | 70 | Thermocurable |
| | paper | | | silicone-based |
| | RRP- | | | releasing agent |
| | 70(T) | | | (BY24-4538/BY24- |
| | | | | 490 = 100/10) |
| Example 4 | Glassine | 0.070 | 70 | Thermocurable |
| | paper | | | silicone-based |
| | RRP- | | | releasing agent |
| | 70(T) | | | (BY24-489/BY24- |
| | | | | 4538/BY24- |
| | | | | 490 = 30/70/10) |
| Example 5 | Glassine | 0.090 | 100 | Thermocurable |
| | paper | | | silicone-based |
| | NSGP- | | | releasing agent |
| | RT100 | | | (AST-8/CATA12070 = |
| | | | | 100/7.3) |
| Example 6 | Glassine | 0.090 | 100 | Thermocurable |
| | paper | | | silicone-based |
| | NSGP- | | | releasing agent |
| | RT100 | | | (AST-8/CATA12070 = |
| | | | | 100/7.3) |
| Comparative | Release | 0.092 | 100 | |
| Example 1 | liner | | | |
| | 100GVW | | | |
| | (14/12) | | | |
| Comparative | Glassine | 0.090 | 100 | Cation |
| Example 2 | paper | | | polymerizable |
| | NSGP- | | | ultraviolet ray |
| | RT100 | | | curable silicone- |
| | | | | based releasing |
| | | | | agent |
| | | | | (X-62-7658/CAT- |
| | | | | 7605 = 100/1) |
| Comparative | Glassine | 0.090 | 100 | Cation |
| Example 3 | paper | | | polymerizable |
| | NSGP- | | | ultraviolet ray |
| | RT100 | | | curable silicone- |
| | | | | based releasing |
| | | | | agent |
| | | | | (X-62-7658/CAT- |
| | | | | 7605 = 100/1) |

TABLE 2

| | Peeling force of | Interlayer strength | Interlayer strength | | |
|---|---|---|---|---|---|
| | release liner | of release liner | of release liner/Peeling | | |
| | (N/50 mm) | (N/50 mm) | force of release liner | Processability | Gel fraction (%) |
| Example 1 | 0.32 | 10.5 | 33.2 | 0/10 | 53 |
| Example 2 | 0.39 | 10.5 | 26.9 | 0/10 | 53 |
| Example 3 | 0.64 | 10.5 | 16.4 | 0/10 | 53 |
| Example 4 | 0.44 | 10.5 | 23.9 | 0/10 | 53 |
| Example 5 | 0.23 | 7.6 | 33.2 | 0/10 | 53 |
| Example 6 | 0.29 | 7.6 | 26.2 | 0/10 | 29 |
| Comparative | 0.63 | 8.0 | 12.6 | 7/10 | 53 |
| Example 1 | | | | | |
| Comparative | 1.05 | 7.6 | 7.2 | 8/10 | 53 |
| Example 2 | | | | | |
| Comparative | 0.96 | 7.6 | 7.9 | 8/10 | 29 |
| Example 3 | | | | | |

As is clear from the evaluation results (Table 2), in ten sample evaluations of the double-sided pressure-sensitive adhesive sheets for which the ratio (interlayer strength of release liner/peeling force of the release liner in peeling test at 90° with respect to the pressure-sensitive adhesive face) of the interlayer strength of the release liner with respect to the peeling force of the release liner in the peeling test at 90° with respect to the pressure-sensitive adhesive face was 15 or more, there was no sample in which the base material of the release liner was interlaminarly ripped from the slit when the release liner in which a slitted pull tab was formed was peeled from the pressure-sensitive adhesive face (Examples 1 to 6).

On the other hand, in the double-sided pressure-sensitive adhesive sheets for which the ratio of the interlayer strength of the release liner with respect to the peeling force of the release liner in the peeling test at 90° with respect to the pressure-sensitive adhesive face was less than 15, in 7 to 8 samples among the ten samples, the base material of the release liner was interlaminarly ripped from the slit and the release liner interlaminarly ripped was left on the pressure-sensitive adhesive face when the release liner in which a slitted pull tab was formed was peeled from the pressure-sensitive adhesive face. (Comparative Examples 1 to 3).

While the invention has been described in detail and with reference to specific embodiments thereof, it will be apparent to one skilled in the art that various changes and modifications can be made therein without departing from the scope thereof.

This application is based on Japanese patent application No. 2011-266993 filed Dec. 6, 2011, the entire contents thereof being hereby incorporated by reference.

What is claimed is:

1. A double-sided pressure-sensitive adhesive sheet, comprising a pressure-sensitive adhesive body having pressure-sensitive adhesive faces (a) and (b) on both sides thereof, and a release liner (A) provided at least on the pressure-sensitive adhesive face (a) of the pressure-sensitive adhesive body,
wherein the release liner (A) comprises a paper-based base material and a release layer on a face of the paper-based base material, said release layer being in contact with the pressure-sensitive adhesive face (a), and
wherein a ratio (an interlayer strength of the release liner (A)/a peeling force of the release liner (A) in a peeling test at 90° with respect to the pressure-sensitive adhesive face (a)) of the interlayer strength of the release liner (A) with respect to the peeling force of the release liner (A) in the peeling test at 90° with respect to the pressure-sensitive adhesive face (a) is 15 or more.

2. The double-sided pressure-sensitive adhesive sheet according to claim 1, wherein the release liner (A) further comprises another release layer on the other face of the paper-based base material, and
wherein the double-sided pressure-sensitive adhesive sheet is wound into a roll form so that said another release layer being in contact with the pressure-sensitive adhesive face (b).

3. The double-sided pressure-sensitive adhesive sheet according to claim 1, which further comprises a release liner (B) provided on the pressure-sensitive adhesive face (b).

4. The double-sided pressure-sensitive adhesive sheet according to claim 1, wherein the peeling force of the release liner (A) in the peeling test at 90° with respect to the pressure-sensitive adhesive face (a) is 0.15 N/50 mm or more.

5. The double-sided pressure-sensitive adhesive sheet according to claim 1, wherein the interlayer strength of the release liner (A) is 5 N/50 mm or more.

6. The double-sided pressure-sensitive adhesive sheet according to claim 1, wherein the pressure-sensitive adhesive body comprises an acrylic pressure-sensitive adhesive layer.

7. The double-sided pressure-sensitive adhesive sheet according to claim 1, wherein said release layer is a release layer formed by a silicone-based releasing agent.

8. The double-sided pressure-sensitive adhesive sheet according to claim 1, wherein the paper-based base material is a paper-based base material selected from a group consisting of glassine paper, wood free paper, and craft paper.

9. The double-sided pressure-sensitive adhesive sheet according to claim 1, wherein the release liner (A) has a thickness of 50 to 200 μm.

10. The double-sided pressure-sensitive adhesive sheet according to claim 1, further comprising a pull tab attached thereto.

11. The double-sided pressure-sensitive adhesive sheet according to claim 10, wherein the release liner (A) comprises the pull tab.

12. The double-sided pressure-sensitive adhesive sheet according to claim 1, which is a double-sided pressure-sensitive adhesive sheet for a flexible printed circuit board.

13. The double-sided pressure-sensitive adhesive sheet according to claim 2, wherein the peeling force of the release liner (A) in the peeling test at 90° with respect to the pressure-sensitive adhesive face (a) is 0.15 N/50 mm or more.

14. The double-sided pressure-sensitive adhesive sheet according to claim 3, wherein the peeling force of the release liner (A) in the peeling test at 90° with respect to the pressure-sensitive adhesive face (a) is 0.15 N/50 mm or more.

15. The double-sided pressure-sensitive adhesive sheet according to claim 2, wherein the interlayer strength of the release liner (A) is 5 N/50 mm or more.

16. The double-sided pressure-sensitive adhesive sheet according to claim 3, wherein the interlayer strength of the release liner (A) is 5 N/50 mm or more.

17. The double-sided pressure-sensitive adhesive sheet according to claim 4, wherein the interlayer strength of the release liner (A) is 5 N/50 mm or more.

18. The double-sided pressure-sensitive adhesive sheet according to claim 2, wherein the pressure-sensitive adhesive body comprises an acrylic pressure-sensitive adhesive layer.

19. The double-sided pressure-sensitive adhesive sheet according to claim 3, wherein the pressure-sensitive adhesive body comprises an acrylic pressure-sensitive adhesive layer.

20. The double-sided pressure-sensitive adhesive sheet according to claim 4, wherein the pressure-sensitive adhesive body comprises an acrylic pressure-sensitive adhesive layer.
